(19) United States
(12) Patent Application Publication
(10) Pub. No.: US 2002/0025805 A1
(43) Pub. Date: Feb. 28, 2002

(54) Remote signalling transmitter for use in various vehicle systems

(75) Inventor: David J. Reimus, Warren, MI (US)

Correspondence Address: LAURA M. SLENZAK, SIEMENS CORPORATION, 186 WOOD AVENUE SOUTH, ISELIN, NJ, 08830, US

(73) Assignee: Siemens Automotive Corporation

(21) Appl. No.: 09/927,165

(22) Filed: Aug. 10, 2001

Related U.S. Application Data
(60) Provisional application No. 60/227,418, filed on Aug. 23, 2000.

(51) Int. Cl. H04B 1/00

(52) U.S. Cl. 455/420; 455/68

(57) ABSTRACT

A remote signaling system includes a transmitter having an oscillator portion. In one example, the oscillator is a Colpitts oscillator having a transistor. An antenna of the transmitter is directly coupled to the emitter of the transistor. With this connection, transmitter efficiency and reliability is increased without introducing additional cost into the system. In one example, the remote signalling device is a transmitter for a remote keyless entry system. In another example, the signalling device is part of a sensor arrangement for monitoring a selected condition of at least one selected vehicle component.

### CROSS-REFERENCE TO RELATED APPLICATION

This application claims priority to U.S. Provisional Application Serial No. 60/227,418, which was filed on Aug. 23, 2000.

### BACKGROUND OF THE INVENTION

This invention generally relates to transmitters used in vehicle control or monitoring systems. More particularly, this invention relates to a unique component arrangement for more efficiently radiating signals from a transmitter.

Remote keyless entry systems typically include a controller, located on a vehicle for example. A remote signalling transmitter provides signals to the controller indicating a desired operation. Many transmitters are embodied in key fobs or portable cards that are carried about by a user.

One challenge constantly facing those in this field is making efficient transmitters that fit within cost budgets and perform satisfactorily. Those skilled in the art are always striving to find ways to reduce power consumption while still providing adequate signal strength, for example.

One difficulty associated with conventional arrangements is that attempts to increase the signal strength of a transmitted signal typically requires larger power consumption or more robust components, both of which introduce undesirable expense into the system. Moreover, the nature of the components used in conventional remote keyless entry transmitters and their arrangement typically introduces harmonic variations whenever signal strength is adjusted outside of specific parameters. Therefore, it is difficult to enhance the operation of such a transmitter without, at the same time, introducing performance variation that must be compensated for using additional components or more expensive components.

The signal transmission problem described above is not limited to signalling used in remote keyless entry systems. The same challenges are faced by those attempting to incorporate various remote signalling devices on a vehicle. One example includes tire pressure sensors. The challenges of having a robust and reliable sensor and transmitter arrangement is further complicated by the presence of surrounding vehicle structure. An additional difficulty is overcoming the variations in signal power caused by rotation of the wheels while the vehicle is in motion.

This invention addresses the need for enhancing the performance of a signalling transmitter without introducing additional cost into the system. A transmitter designed according to this invention provides more efficient operation and reduced harmonic effects on the performance of the circuitry or components of the transmitter.

### SUMMARY OF THE INVENTION

In general terms, this invention is a remote signalling transmitter having an antenna directly coupled to an emitter of a transistor in the oscillator portion of the transmitter.

A transmitter designed according to this invention includes a signal source. An oscillator processes the signal from the signal source and puts it into a form that is suitable for transmission to a remotely located receiver. The oscillator includes a transistor having a base, collector and emitter. An antenna is directly coupled to the emitter of the transistor.

By directly coupling the antenna to the emitter, less current is required to achieve adequate radio frequency power for transmitting signals from a transmitter to a receiver. Because less current is required, greater signal strength is possible without introducing cost into the system or reducing the life of a battery of the transmitter. With an antenna coupled directly to an emitter, the antenna can have a greater mass, which makes the antenna a more efficient radiator and enhances the performance of the transmitter.

In one example, the transmitter is a part of a remote keyless entry system. In another example, the transmitter is a part of a tire pressure monitoring arrangement.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates a vehicle including example systems having a transmitter designed according to this invention.

FIG. 2 schematically illustrates selected portions of a transmitter designed according to this invention.

FIG. 3 schematically shows a somewhat larger view of the portion of FIG. 1 encircled at 3.

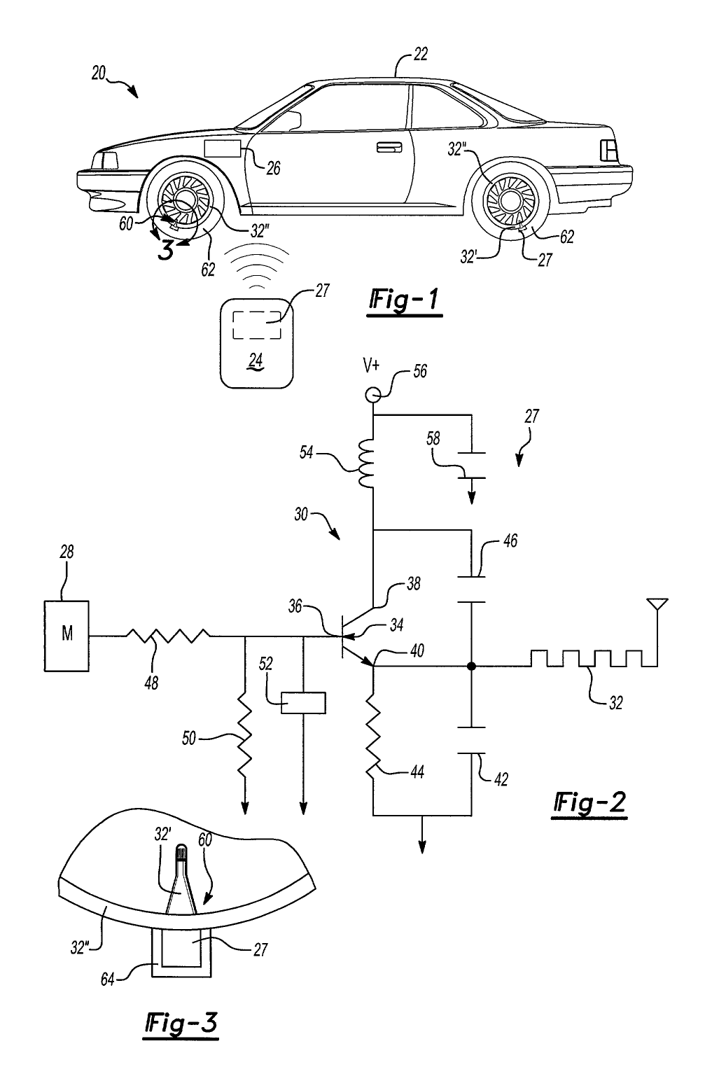

### DETAILED DESCRIPTION OF THE PREFERRED EMBODIMENT

A remote signalling system 20 for a vehicle 22 includes a remote keyless entry portion and a vehicle component monitoring portion. In this particular example, the vehicle component monitoring portion includes a tire pressure monitoring arrangement.

The remote keyless entry portion includes a signaling device 24 that provides a signal to a controller 26 supported on the vehicle 22. The signaling device 24 has a transmitter 27, which in one example is embodied into a key fob that includes switches that are manually operated to generate signals indicating a desired operation to the controller 26. In another example, the signaling device 24 is a passive device embodied in a card that is portable, which includes the transmitter 27 that emits a signal without requiring manual activation by a user. A variety of signaling devices may be used within the scope of this invention.

The transmitter 27 preferably includes a microprocessor 28 that performs various functions including providing a source signal for transmission by the transmitter 27. An oscillator 30, which in the illustrated example is a Colpitts oscillator, processes a signal from the signal source 28 and puts it into a form that is suitable for being transmitted from the transmitter 27 to the controller 26. An antenna 32 effectively transmits the signal from the oscillator 30 such that the receiver portion of the controller 26 receives a recognizable signal. In one example, radio frequency signals are used.

The oscillator 30 includes a transistor 34 having a base 36, a collector 38 and an emitter 40. The antenna 32 is coupled directly to the emitter 40 of the transistor 34. This direct coupling provides substantial advantages compared to prior transmitter arrangements where the antenna 32 is coupled to another portion of the oscillator circuit. The arrangement of this invention provides for greater stability and better transmitter performance without introducing additional cost into the system. Having the antenna 32 directly coupled to the emitter 40 makes the transmitter 24 more efficient because less current is required to achieve higher signal strengths while simultaneously reducing the oscillator harmonics. Another advantage of this invention is that the rise time and fall time of the oscillator 30 are reduced. As known in the art, there is a delay between the actual signals transmission from the oscillator 30 compared to the source signal from the microprocessor 28. With the antenna 32 directly coupled to the emitter 40, the rise time and fall time of the oscillator 30 is reduced, which renders the performance of the transmitter 24 more accurate and reliable. Additionally, coupling the antenna 32 directly to the emitter 40 allows for greater variation in antenna design.

A transmitter designed according to this invention can include a much larger antenna 32 compared to previous designs. In one example signalling device for remote keyless entry communications, the antenna 32 is a trace on a printed circuit board. Because of the direct coupling between the antenna 32 and the emitter 40, the typical LC factor introduced by the antenna is not present and the antenna 32 can have a much longer length or larger mass than was previously achievable. In prior designs, the length of the antenna was substantially limited by a requirement to reduce the inductance, which allows for a longer trace to keep the desired frequency.

A capacitive element 42 and a resistive element 44 are coupled in parallel between the emitter 40 and ground. Another capacitive element 46 preferably is coupled between the collector 38 and the capacitive element 42. The connection between the antenna 32 and the emitter 40 preferably is also coupled to a node between the capacitive elements 42 and 46. The capacitive element 42 preferably is provided to sharpen the bit width and to provide signal control on the feedback loop back to the base 36 of the transistor 34. The capacitive element 46 preferably is provided to stabilize the oscillator performance.

A voltage divider circuit comprising resistors 48 and 50 preferably is included to provide temperature stability to the transmitter 27. Another element 52 preferably is provided to prevent harmonics in the feedback signals of the oscillator 30. In one example, the element 52 is a capacitor. In another example, the element 52 is a SAW oscillator.

The illustrated example includes an inductive element 54 coupled between the collector 38 of the transistor 34 and a voltage source 56, which is a battery. The inductive element 54 preferably is chosen to tune the oscillator 30. A capacitive element 58 preferably is coupled between the voltage source 56 and ground.

This invention is not limited to remote keyless entry system transmitters. Other signalling devices using remote communication (i.e., where signals are transmitted without using hard wired connections between a signal source and a signal destination) advantageously include the concepts of this invention.

A tire pressure sensing arrangement 60 includes a transmitter portion 27 preferably designed as discussed above. The sensor arrangement 60 provides remote signals to the controller 26 indicating pressure or other selected conditions of the vehicle tires 62. A sensor 64 preferably is positioned relative to the tire 62 to acquire the data necessary to provide the desired information. The transmitter portion 27 preferably is supported relative to the valve stem 32′ of the wheel so that the valve stem 32′ operates as the antenna of the transmitter portion 27. Additionally, the wheel rim 32″ serves as the antenna. In one example, the material characteristics of the valve stem 32′ and the wheel rim 32″ and the conventional arrangement of the stem and rim provide a sufficient electrical connection such that the valve stem and wheel rim are electrically coupled and both operate as the antenna or radiator of the transmitted signal. In one example, only the wheel rim 32″ operates as the antenna.

The valve stem 32′ and the wheel rim 32″ preferably are directly coupled to the emitter 40 of the transistor 34 so that the advantages of this invention are achieved. Utilizing the entire wheel rim 32″ as an antenna becomes possible when incorporating the concepts of this invention. Utilizing the entire wheel rim 32″ as an antenna provides substantial advantages because the signal transmission problems associated with prior tire sensor arrangements are avoided (such as a loss of signal strength as the sensor and its associated antenna rotate while the vehicle is moving). Having the larger mass of the wheel rim 32″ provides stronger signals. Moreover, having the entire wheel rim 32′ serve as an antenna eliminates unwanted variations in the signal communicated from the sensor 64 to the controller 26.

The various components of the example embodiments of this invention such as the controller 26, sensor 64 and signalling device 24 are schematically illustrated. Those skilled in the art who have the benefit of this description will be able to select from among commercially available components or to custom design components such that they operate according to this description.

The preceding description is exemplary rather than limiting in nature. Variations and modifications to the disclosed example may become apparent to those skilled in the art that do not necessarily depart from the essence of this invention. The scope of legal protection given to this invention can only be determined by studying the following claims.

I claim:

1. A transmitter for use in a remote signalling system, comprising:
a signal source;
an oscillator that puts a signal from the signal source into a transmittable form, the oscillator including a transistor having an emitter; and
an antenna that is coupled directly to the transistor emitter, the antenna transmitting the oscillator signal.

2. The transmitter of claim 1, wherein the antenna comprises a trace on a printed circuit board.

3. The transmitter of claim 1, wherein the oscillator comprises a Colpitts oscillator.

4. The transmitter of claim 3, including a first capacitive element in parallel with a resistive element both coupled between the emitter and ground.

5. The transmitter of claim 4, including a second capacitive element in series with the first capacitive element between the first capacitive element and the collector of the transistor and wherein the coupling between the antenna and the emitter is also coupled between the first and second capacitive elements.

6. The transmitter of claim 1, including a voltage source and an inductive element coupled to the collector of the transistor.

7. The transmitter of claim 1, wherein the antenna comprises at least a portion of a wheel.

8. A remote keyless entry system, comprising:
a controller that performs an action based upon a received signal; and
a transmitter that remotely transmits a signal to the controller, the transmitter including a signal source, an oscillator that puts a signal from the signal source into a transmittable form and includes a transistor having an emitter, and an antenna that is coupled directly to the transistor emitter, the antenna transmitting the oscillator signal.

9. The system of claim 8, wherein the antenna comprises a trace on a printed circuit board.

10. The system of claim 8, wherein the oscillator comprises a Colpitts oscillator.

11. The system of claim 10, including a first capacitive element in parallel with a resistive element both coupled between the emitter and ground.

12. The system of claim 11, including a second capacitive element in series with the first capacitive element between the first capacitive element and the collector of the transistor and wherein the coupling between the antenna and the emitter is also coupled between the first and second capacitive elements.

13. A vehicle component monitoring system, comprising:
a controller supported on the vehicle that receives and interprets signals indicating a condition of at least one selected vehicle component; and
a sensor device associated with the selected vehicle component that remotely transmits a signal to the controller, the sensor device including a signal source, an oscillator that puts a signal from the signal source into a transmittable form and includes a transistor having an emitter, and an antenna that is coupled directly to the transistor emitter.

14. The system of claim 13, wherein the antenna comprises a valve stem on a vehicle wheel.

15. The system of claim 14, wherein the antenna additionally comprises a rim of the vehicle wheel.

16. The system of claim 13, wherein the antenna comprises a wheel rim.

17. The system of claim 13, wherein the oscillator comprises a Colpitts oscillator.
